(19) United States
(12) Patent Application Publication
(10) Pub. No.: US 2008/0114700 A1
(43) Pub. Date: May 15, 2008

(54) SYSTEM AND METHOD FOR OPTIMIZED ASSET MANAGEMENT

(76) Inventors: Norman T. Moore, Carpentersville, IL (US); Jim Devanna, Altamonte Springs, FL (US); Alexander Cameron Sedgwick, Vienna, VA (US)

Correspondence Address: PILLSBURY WINTHROP SHAW PITTMAN, LLP, P.O. BOX 10500, MCLEAN, VA, 22102, US

(21) Appl. No.: 11/558,795

(22) Filed: Nov. 10, 2006

(51) Int. Cl. G06Q 40/00

(52) U.S. Cl. 705/36 R

(57) ABSTRACT

The invention provides a system and method for optimizing asset management within an organization. The invention includes an asset management database that comprises the identity of a plurality of assets managed by the organization and associations between at least one of the plurality of assets and one or more existing organizational requirements serviced by the at least one of the plurality of assets.

### FIELD OF THE INVENTION

The invention relates to a system and method for optimizing asset discovery and management within an organization. More particularly, the invention relates to optimizing asset management by identifying heretofore unidentified efficiencies to maximize asset utilization within an organization.

### BACKGROUND OF THE INVENTION

Assets within an organization are often acquired and/or used for singular or narrow purposes. Moreover, those assets utilized for multiple purposes are typically utilized by a single subsection group, or division, of an organization. As such, the capabilities of organizational assets are realized by only a limited portion of the organization. These “asset silos” lead to multiple inefficiencies within the organization.

Thus, there is a need for systems and methods for identifying assets and asset capabilities across organizational boundaries to optimize asset efficiencies.

### SUMMARY OF THE INVENTION

The invention solving these and other problems relates to a system and method for optimizing asset discovery and management within an organization. In one embodiment, the invention comprises an asset management database that enables tracking of associations between assets managed by an organization, metrics associated with managed assets, and business services supported by managed assets.

In some embodiments, the asset management database may be assembled by identifying the assets managed by the organization to establish a baseline of the items/assets that the organization has at its disposal. For some or all of the identified assets, one or more of the business services currently supported (either partially or fully) by an asset are identified and mapped to the asset within the asset management database. Also, one or more metrics associated with assets managed by the organization may be measured. These metrics may include one or more of consumer demand, requirements, capacity, corporate budgets, procurement, receiving, matching, reconciling, deploying, discovering, maintenance, entitlements, repurpose, and disposal. Other metrics may also be used.

The metrics and business service associations of individual assets form part or all of a “profile,” or set of data, regarding each asset. In some embodiments, these individual profiles may be used to construct an asset usage model. An asset usage model comprises a logical representation of the interactions of one or more assets, the business services they support, and/or one or more metrics associated with the assets. For example, an asset usage model may illustrate two assets that support a certain business process within the organization. The same asset usage model may also provide the specific metrics regarding the assets and/or specific metrics regarding each asset as they each relate to the supported business process.

In another example, the asset usage model may illustrate that a certain asset supports more than one business process within the organization. In this example, the metrics illustrated in the asset usage model may be specific to the asset and/or each individual business process supported by the asset.

The above examples of asset usage models illustrate two-asset/one-service and one-asset/two-service implementations. These examples can be extrapolated to illustrate the capability of the asset management database to represent a complex web of assets, services, and related values. In some embodiments, a subset of large/complex asset usage models may be selected through, for example, queries or other information requests posed to the asset management database which may “slice and dice” the organization's asset usage in any number of customizable ways. In some embodiments, the entirety of an organization's assets can be captured in a comprehensive asset usage model. Accordingly, asset metrics or values may also be selected and/or displayed in any number of different ways.

The ability to produce asset usage models enables the identification of existing asset usage efficiencies. Furthermore, these models enable an organization to recognize and implement heretofore unrealized efficiencies by providing a comprehensive view of asset interactions. For example, through the use of an asset usage model, it may be discovered that a certain asset is underused and/or that use of the remaining capability of the underused asset may aid certain underperforming services or business processes. Efficiencies may be realized by changing attributes within the asset usage models and implementing the resultant logical model outcome within the organization.

In some embodiments, the invention includes a method for optimizing asset management by utilizing an asset management database to address organizational requirements. The method includes identifying an organizational requirement and determining whether the organizational requirement is serviceable using existing assets managed by the organization. This determination may be made by identifying the attributes of the organizational requirement and searching the assets (and/or their metrics or other characteristics) within the asset management database to determine if any of the existing assets can be used to service the organizational requirement.

For example, an organization may begin a new project and require certain information technology infrastructure to service the new project. The known attributes of the new project may be used to search the asset management database to determine whether the project is partially or entirely serviceable using the assets in the existing information technology infrastructure. Asset usage models produced using the asset management database may also be utilized to perform this search. The use of the asset management database/asset usage models in this manner enables farther reaching and more comprehensive use of assets where previous communication and informational barriers would have prevented identification of assets to meet new organizational demands.

If it is determined that the organizational requirement, or part thereof, can be serviced using existing assets, the asset profiles of service providing assets may be updated to reflect their association with the organizational requirement. As such the asset management database and any asset usage models arising therefrom may reflect these new associations. In some embodiments, update of the asset management database may not occur until the assets are actually deployed to the organizational requirement.

In some embodiments, it may be determined that existing organizational assets are not immediately available to service a new organizational requirement but that certain modifications to either or both of the assets or the organizational requirement may be undertaken to reach the same or similar goal using existing assets. In these embodiments, identification of the specific modifications (either to the assets themselves or the requirements) needed for the use of existing assets must be first accomplished before existing assets can be deployed to support the new requirement. Details regarding these modifications can be noted and stored in the asset management database appropriately.

If a search of the asset management database reveals that part or all of the organizational requirement is not serviceable using existing organizational assets, then the organization may initiate steps to procure the necessary assets. In some embodiments, the organizational requirement may go through a validation process within the organization prior to the determination of whether existing assets are sufficient. In other embodiments, this validation may occur only after it is determined that existing assets are insufficient.

If existing assets are deemed insufficient and any necessary validation occurs, a procurement request for the additional assets necessary to service the organizational requirement may be generated. The procurement request may include taking one or more steps within an organization to identify a vendor capable of providing the additional assets. Identifying such a vendor may include considering existing relationships with vendors (e.g., existing contractual relationships), performance of assets, failure rates of assets, accuracy of delivery times, comparative cost of asset support, approving any proposed terms for acquiring the additional assets, and/or other operations.

Once a vendor is identified and terms are reviewed, one or more purchase orders for approved asset purchases may be generated and the additional assets may be acquired. The asset management database and/or any asset-usage models may be updated with the identities and characteristics of the additional assets and may be updated with associations between the organizational requirement and the additional assets. As such, any existing or potential organizational efficiencies enabled by the additional assets can be discerned using the updated asset management database.

In some embodiments, the asset management database may include information relating to known problems relating to the one or more assets. This information may be used when determining whether the organizational need can be (or should be) serviced using existing assets. This asset problem information may also include information relating to vendor products, such that problems with potential additional assets that may be acquired from vendors to service organizational requirements can be taken into account as to when, how, and from whom to acquire additional assets to meet organizational needs.

In some embodiments, the asset management database may include information relating to service level management for business services provided by the one or more assets. This service level management information may be used when determining whether an organizational requirement is serviceable using existing assets. In some implementations, service level agreements may define a certain level of service to be provided to a consumer such as, for example, deployment times, performance times, repair times, outage requirements, retirement of asset metrics, and/or other service parameters. In one example, the addition of a particular organizational requirement to the burdens borne by a particular group of assets may negatively affect the service level provided to other services. In another example, the burden of servicing the operational requirement may not immediately harm the level of service provided by existing assets, but those existing assets may operate under a service level agreement guaranteeing a certain high level of service. As such, use of the existing assets for the new organizational requirement may pose a greater risk to stress-related breakdowns, for example, and as such, the existing assets may be left untouched so as to consistently provide more stress-poof service under the service level agreement. Other uses of service level information are contemplated.

The asset management database captures all asset interactions, enabling visualization of the complex transitions an asset makes throughout its lifecycle in an organization. For example, if an asset were obtained/purchased for a particular project, the asset management database and/or asset usage models of the invention may enable re-allocation of the asset to a different project at the completion of the initial project or for practical uses concurrent to the initial project. This enables more efficient use of assets within the organization.

The invention also enables measurement of the effectiveness of an asset by defined practices that can be measured against aggregates of industries also implementing asset management databases according to the invention.

The methods and systems of the invention bring together generally accepted accounting practices (GAAP) and asset management into one comprehensive process for optimizing asset management where complex relationships are present. This allows for the reconciliation of costs incurred for hardware and service and the ability to manage depreciation and expenses balance sheets during the accounting process. The elucidation of these relationships by the systems and methods of the invention expose all interactions and values chains related to an asset. Matching value to assets in this manner enables management of assets similar to the manner in which accountants manage financial budgets and internal controls for audits. This type of asset management enables IT professionals and business leaders to make the same decisions as they would when looking at an income statement, balance sheet, or cash flow. In some embodiments, the invention may utilize continuous accounting procedures to optimize assets, which allows for the plugging of financial information directly into an accounting system (e.g., depreciation, expenses, income from investments, sales or services from assets to be reconciled for submission to the offices of the CFO, and/or other information).

In some embodiments, the invention also includes a system and method for transitioning an organization from a low level of asset management maturity to a higher level of asset management maturity.

These and other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an example of a process for constructing an asset management database, according to an embodiment of the invention.

FIG. 2 illustrates an example of a process for addressing organizational requirements using an asset management database, according to an embodiment of the invention.

FIG. 3A illustrates an example of a process flow diagram for an Active asset management maturity level, according to an embodiment of the invention.

FIG. 3B illustrates an example of characteristics for an Active asset management maturity level, according to an embodiment of the invention.

FIG. 4A illustrates an example of a process flow diagram for an Efficient asset management maturity level, according to an embodiment of the invention.

FIG. 4B illustrates an example of characteristics for an Efficient asset management maturity level, according to an embodiment of the invention.

FIG. 5A illustrates an example of a process flow diagram for an Responsive asset management maturity level, according to an embodiment of the invention.

FIG. 5B illustrates an example of characteristics for an Responsive asset management maturity level, according to an embodiment of the invention.

FIG. 6A illustrates an example of a process flow diagram for an Business-Driven asset management maturity level, according to an embodiment of the invention.

FIG. 6B illustrates an example of characteristics for an Business-Driven asset management maturity level, according to an embodiment of the invention.

FIG. 7 illustrates an example of a summary best practices blueprint, according to an embodiment of the invention.

FIG. 8 illustrates an example of a process for improving an organization's asset management maturity level, according to an embodiment of the invention.

FIG. 9 illustrates an example of a integrated information technology flow, according to an embodiment of the invention.

FIG. 10 illustrates an example of a integrated information technology flow, according to an embodiment of the invention.

FIG. 11 illustrates an example of a integrated information technology flow, according to an embodiment of the invention.

FIG. 12 illustrates an example of a system for optimizing asset management, according to an embodiment of the invention.

### DETAILED DESCRIPTION

The invention provides systems and methods for optimizing asset discovery and management within an organization. In some embodiments, the invention includes an asset management database that enables tracking of associations between assets managed by an organization, metrics associated with managed assets, and business services supported by managed assets.

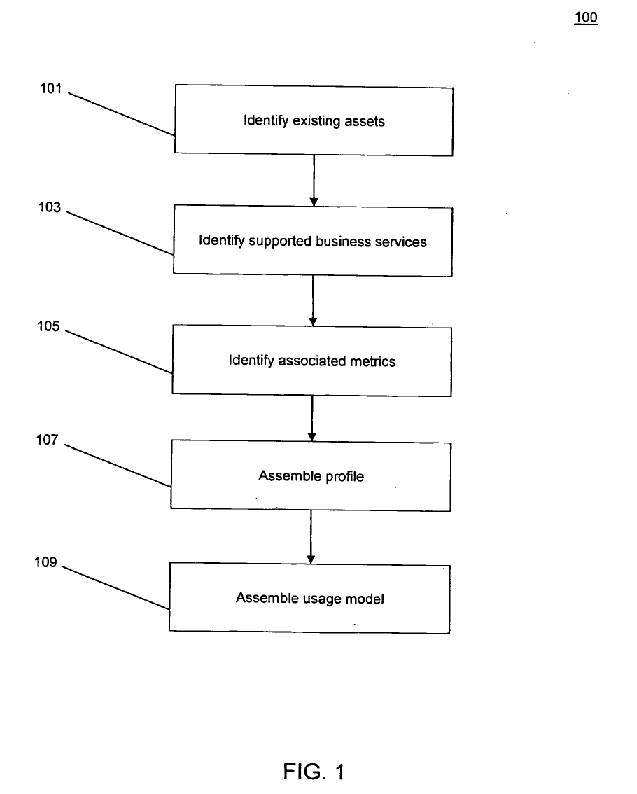

FIG. 1 illustrates a process 100, which is an example of a process for assembly of an asset management database according to an embodiment of the invention. In an operation 101, some or all of the assets managed by an organization may be identified to establish a baseline of the items/assets that the organization has at its disposal. In an operation 103, for some or all of the identified assets, one or more business processes/business services currently supported (either partially or fully) by an asset are identified and mapped to the asset within the asset management database. In an operation 105, one or more metrics associated with assets managed by the organization may be measured. In some embodiments, the metrics may include metrics related to configuration, including subordinate-master configurations, peer-to-peer configuration and metrics related to business processes or other organizational metrics such as, for example, one or more metrics representing consumer demand, requirements, capacity, corporate budgets, procurement, receiving, matching, reconciling, deploying, discovering, maintenance, entitlements, repurpose, and disposal. Other metrics or bases therefore may be used.

In some embodiments, metrics may be based, for example, on the number of requests for the asset, space available left on a hard drive of the asset, utilization of capacity of the asset, a required percent of expense/revenue budgets, time for approval of asset deployment, procurement of the asset, time from purchase to receipt, accuracy of purchase order and invoice matching, time for payment, identification of asset and reconciling with ownership database, maintenance times to repair, disposal of assets, and/or liabilities.

In some embodiments, an automated discovery agent may be used to identify assets managed by an organization, identify business processes/services supported by assets within the organization, map assets to processes/services, identify metrics associated with assets, and/or perform other tasks. The automated discovery agent may comprise a software module or other computer-implemented module operable within the systems and methods described herein and/or with other systems and methods. In some embodiments, the automated discovery agent may include an industry discovery tool such as, for example, Microsoft™ SMS, Unicenter™ Asset Management from Computer Associates, Altiris™, or other tools.

In an operation 107, the metrics and business service associations of individual assets are used to form part or all of a “profile,” or set of data, regarding each asset. In an operation 109, these individual profiles may be used to construct an asset usage model. In one instance, an asset usage model comprises a logical representation of the interactions of one or more assets, the business services they support, and/or one or more metrics associated with the assets. For example, an asset usage model may illustrate two assets that support a certain business process within the organization. The same asset usage model may also provide the specific metrics regarding the assets and/or specific metrics regarding each asset as they each relate to the supported business process. In another example, the asset usage model may illustrate that a certain asset supports more than one business process within the organization. In this example, the metrics illustrated in the asset usage model may be specific to the asset and/or each individual business process supported by the asset.

The above examples of asset usage models illustrate two-asset/one-service and one-asset/two-service implementations. These examples can be extrapolated to illustrate the capability of the asset management database to represent a complex web of assets, services, and related values. In some embodiments, a subset of large/complex asset usage models may be selected through, for example, queries or other information requests posed to the asset management database which “slice and dice” the organization's asset usage in any number of customizable ways. In some embodiments, the entirety of an organization's assets can be captured in a comprehensive asset usage model. Accordingly, asset metrics or values may also be selected and/or displayed in any number of different ways.

The ability to produce asset usage models enables the identification of existing asset usage efficiencies. Furthermore, these models enable an organization to recognize and implement heretofore unrealized efficiencies by providing a comprehensive view of asset interactions. For example, through the use of an asset usage model, it may be discovered that a certain asset is underused and/or that use of the remaining capability of the underused asset may aid certain underperforming services or business processes. Efficiencies may be realized by changing attributes within the asset usage models and implementing the resultant logical model outcome within the organization.

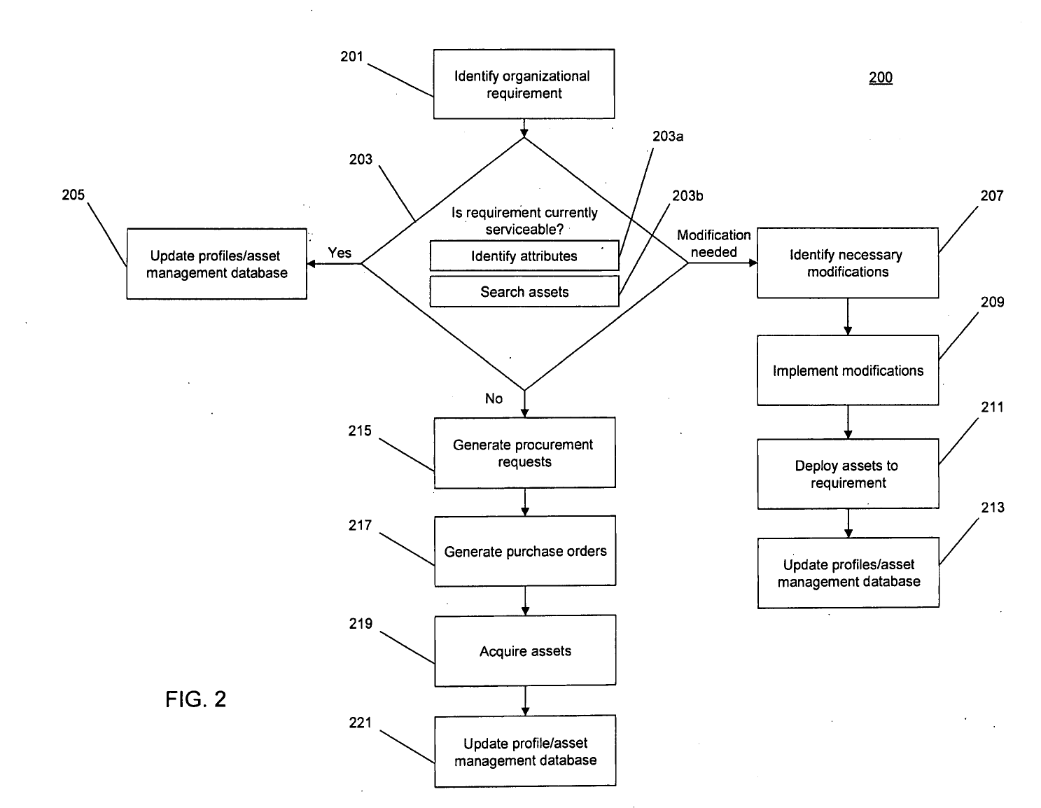

In one embodiment, the invention includes a method for optimizing asset management by utilizing an asset management database to address organizational requirements. FIG. 2 illustrates a process 200, which is an example of a process wherein an asset management database may be used to address business requirements of an organization. Process 200 includes an operation 201 wherein an organizational requirement is selected, presented or otherwise identified. In an operation 203, a determination is made regarding whether the identified organizational requirement is serviceable using existing assets managed by the organization. In making this determination, the attributes of the organizational requirement are identified in an operation 203a. In an operation 203b, the assets currently managed by the organization (and/or their metrics or other characteristics) and represented within the asset management database may be searched to determine if any of the existing assets can be used to service the organizational requirement. The attributes identified in operation 203a are compared against the assets searched in operation 203b to determine whether the organizational requirement can be met by the assets currently managed by the organization.

For example, an organization may begin a new project and require certain information technology infrastructure to service the new project. The known attributes of the new project may be used to search the asset management database to determine whether the project is partially or entirely serviceable using the assets in the existing information technology infrastructure. Asset usage models produced using the asset management database may also be utilized to perform this search. The use of the asset management database/asset usage models in this manner enables farther reaching and more comprehensive use of assets where previous communication and informational barriers would have prevented identification of assets to meet new organizational demands.

If, in operation 203, it is determined that the organizational requirement, or part thereof, can be serviced using existing assets, the assets may be deployed to the organizational requirement and the asset profiles of service providing assets may be updated in an operation 205 to reflect their association with the organizational requirement. As such the asset management database and any asset usage models arising therefrom may reflect these new associations. In some embodiments, update of the asset management database may not occur until the assets are actually deployed to the organizational requirement.

In some instances, it may be determined in operation 203 that existing organizational assets are not immediately available to service a new organizational requirement but that certain modifications to either or both of the assets or the organizational requirement may be undertaken to reach the same or similar goal using existing assets. In these instances, identification of the specific modifications (either to the assets themselves or the requirements) needed for the use of existing assets must be first accomplished in an operation 207. The modifications may then be made in an operation 209 and the existing assets can then be deployed to support the new requirement, in an operation 211. Details regarding these modifications may be noted and stored in the asset management database appropriately in an operation 213.

If, in operation 203, a search of the asset management database reveals that part or all of the organizational requirement is not serviceable using existing organizational assets, then the organization may initiate steps to procure the necessary assets. In some embodiments, the organizational requirement may go through a validation process within the organization prior to the determination of whether existing assets are sufficient. In other embodiments, this validation may occur only after it is determined that existing assets are insufficient.

If existing assets are deemed insufficient and any necessary validation occurs, a procurement request for the additional assets necessary to service the organizational requirement may be generated, in an operation 215. The procurement request may include taking one or more steps within an organization to identify a vendor capable of providing the additional assets. Identifying such a vendor may include considering existing relationships with vendors (e.g., existing contractual relationships), performance of assets, failure rates of assets, accuracy of delivery times, comparative cost of asset support, approving any proposed terms for acquiring the additional assets, and/or other operations.

Once a vendor is identified and terms are reviewed, one or more purchase orders for approved asset purchases may be generated in an operation 217. In an operation 219, the additional assets may be acquired. In an operation 221, the asset management database and/or any asset-usage models may be updated with the identities and characteristics of the additional assets and may be updated with associations between the organizational requirement and the additional assets. As such, any existing or potential organizational efficiencies enabled by the additional assets can be discerned using the updated asset management database.

In one embodiment, the asset management database may include information relating to known problems relating to the one or more assets. This information may be used when determining whether the organizational need can be (or should be) serviced using existing assets. This asset problem information may also include information relating to vendor products, such that problems with potential additional assets that may be acquired from vendors to service organizational requirements can be taken into account as to when, how, and from whom to acquire additional assets to meet organizational needs.

In one embodiment, the asset management database may include information relating to service level management for business services provided by the one or more assets. This service level management information may be used when determining whether an organizational requirement is serviceable using existing assets. In some embodiments, service level agreements may define a certain level of service to be provided to a consumer such as, for example, deployment times, performance times, repair times, outage requirements, retirement of asset metrics, and/or other service parameters. In one example, the addition of a particular organizational requirement to the burdens borne by a particular group of assets may negatively affect the service level provided to other services. In another example, the burden of servicing the operational requirement may not immediately harm the level of service provided by existing assets, but those existing assets may operate under a service level agreement guaranteeing a certain high level of service. As such, use of the existing assets for the new organizational requirement may pose a greater risk to stress-related breakdowns, and as such, the existing assets may be left untouched so as to consistently provide more stress-poof service under the service level agreement. The preceding description of the use of service level information in asset management are examples only. Other uses of service level information are contemplated.

In one implementation, the invention provides a method for optimizing an organization's asset management by improving the asset management maturity level of the organization. In this implementation, a plurality of asset management maturity levels may initially be defined and arranged in a hierarchy or increasing maturity (e.g., maturity level 1, level 2, level 3, etc.). These maturity levels may each define a set of processes for asset management within an organization. These maturity levels may be used in one or more ways as a guide for improving a real-world organization's asset management policies, processes, and infrastructure.

In one embodiment, the plurality of predefined asset management maturity levels may include, for example, an “Active” maturity level, an “Efficient” maturity level, a “Responsive” maturity level, a “Business-Driven” maturity level, or other maturity levels. In some embodiments, these maturity levels may be organized as a hierarchy such as, for example, an Active maturity level being designated as the least developed or lowest maturity level, an Efficient maturity level being considered higher or more developed than the Active maturity level, a Responsive maturity level being considered higher or more developed than the Efficient maturity level, and a Business-Driven maturity level being designated as the highest or most developed maturity level. This hierarchical arrangement may reflect increasing levels of complexity, return on investment for the organization, or other qualities. These defined maturity levels and their arrangement in a hierarchy may provide a stepwise framework for advancing an organization's asset management to a level that meets or exceeds industry best practices.

In some embodiments, each of the maturity levels in the hierarchy may be assigned a numerical indicator indicative of each maturity level's place in the hierarchy such as, for example, level 1 for Active maturity levels, level 2 for Efficient maturity levels, level 3 for Responsive maturity levels, level 4 for Business-Driven maturity levels, or other numerical indicators for other maturity levels. These numerical indicators may be used in place of, or in addition to, any other nomenclature or labels associated with individual maturity levels. It should be noted that the labels “Active,” “Efficient,” “Responsive,” and “Business-Driven” are examples only. Other labels representing any number of hierarchically organized maturity levels may be used.

Improvement of an organization's asset management may involve moving the organization from a lower maturity level (e.g., Active) to a higher maturity level (e.g., Efficient). In some embodiments, the organization may be moved incrementally up several maturity levels (e.g., Active to Efficient, Efficient to Responsive, Responsive to Business-Driven). While movement of an organization incrementally up maturity levels may be optimal in many cases, movement up maturity levels while bypassing intermediate levels may also be possible (e.g., Efficient to Business-Driven). Additionally, because each maturity level, may define a specific set of policies, processes, and/or infrastructure for asset management within an organization, not all organizations may desire, or be able to move to all maturity levels (e.g., a Business-Driven maturity level may not be appropriate for some organizations). As such, an organization may be moved to a maturity level that is higher than its current maturity level, but that is not the highest maturity level in the hierarchy. Additionally, because some organizations may have previously developed a somewhat sophisticated asset management structure, an organization's current maturity level may not necessarily be the lowest maturity level in the hierarchy.

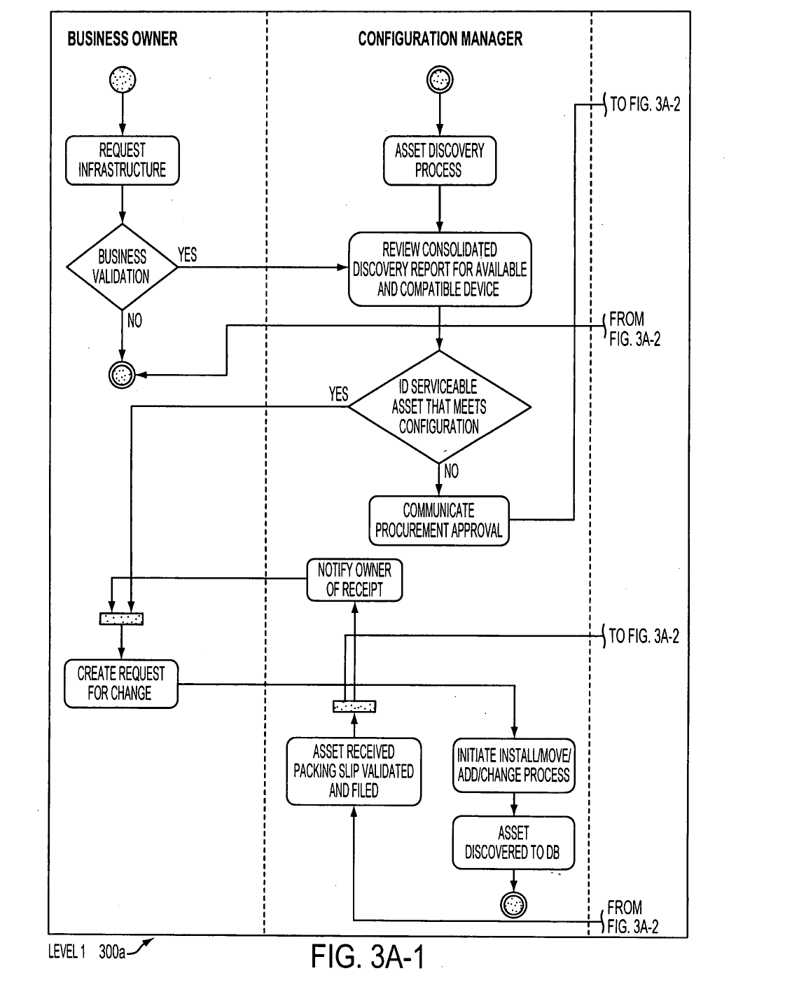

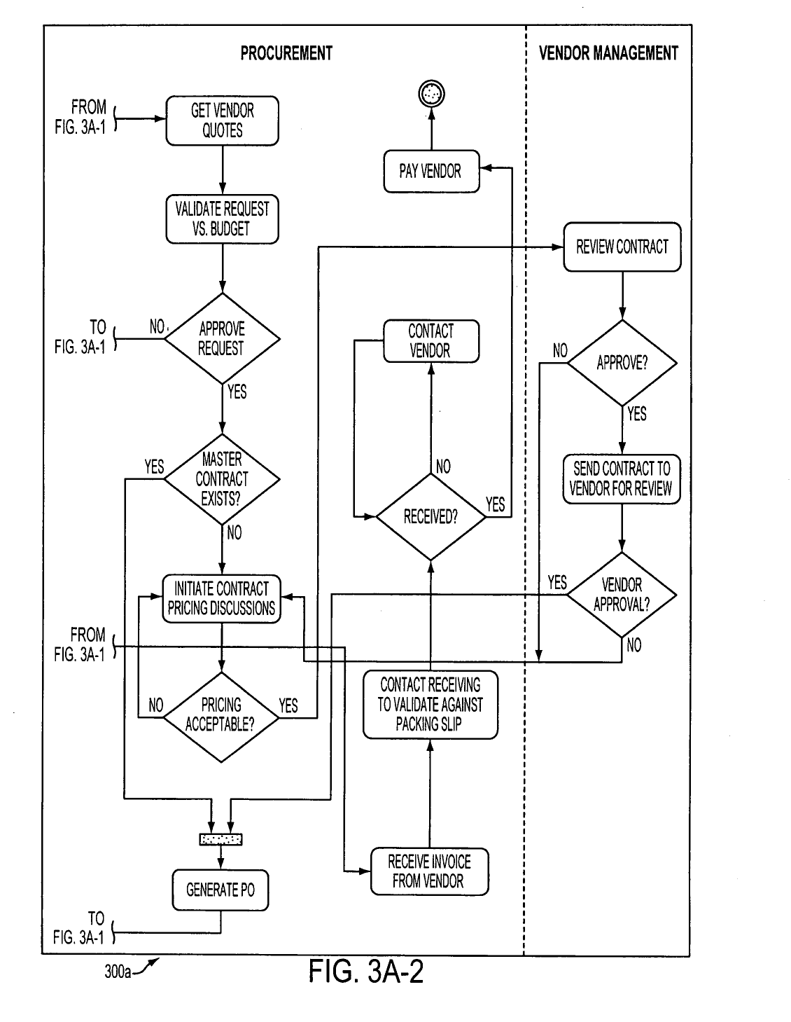

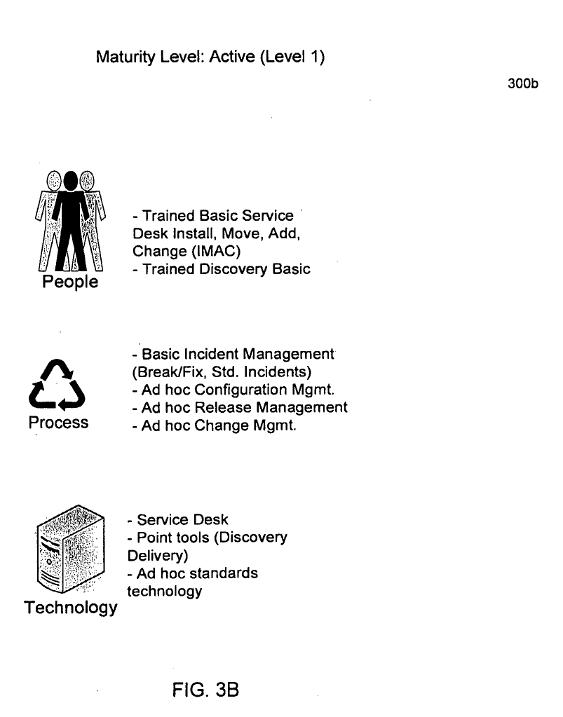

In one embodiment, defining the one or more predefined maturity levels in the hierarchy may include constructing blueprints, lists, charts, diagrams, or other documents or resources for each of the plurality of predefined maturity levels. These resources may be utilized to provide a definition of the people, processes, technology, or other elements of an asset management maturity level. In one embodiment, these resources may comprise process diagrams or flow charts that outline the specific process used in asset management, including the specific personnel or departments within the organization that are involved in performing each of the processes. FIGS. 3A through 6B illustrate examples of process flows and infrastructure characteristics for asset management process maturity levels. For example, FIG. 3A illustrates a process flow diagram 300a for an Active asset management maturity level detailing actors, initial states, activities, decisions, and end states. FIG. 3B illustrates a list 300b detailing a standardized set of people, processes, technology, and other characteristics that comprise an organization operating at an Active asset management maturity level.

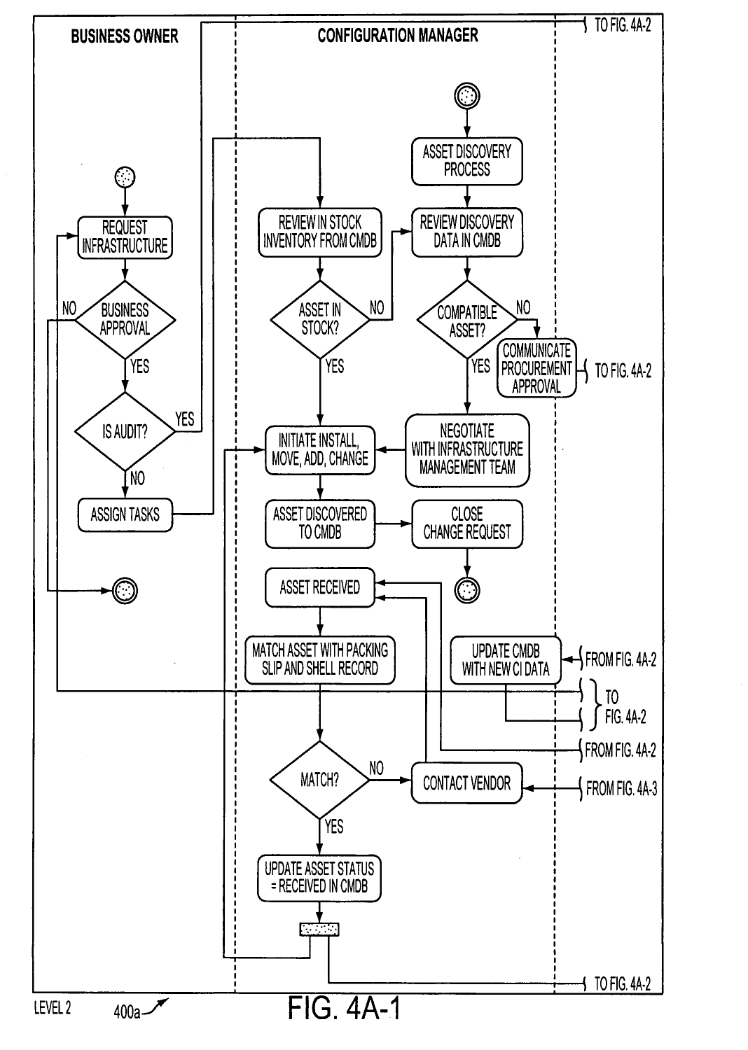

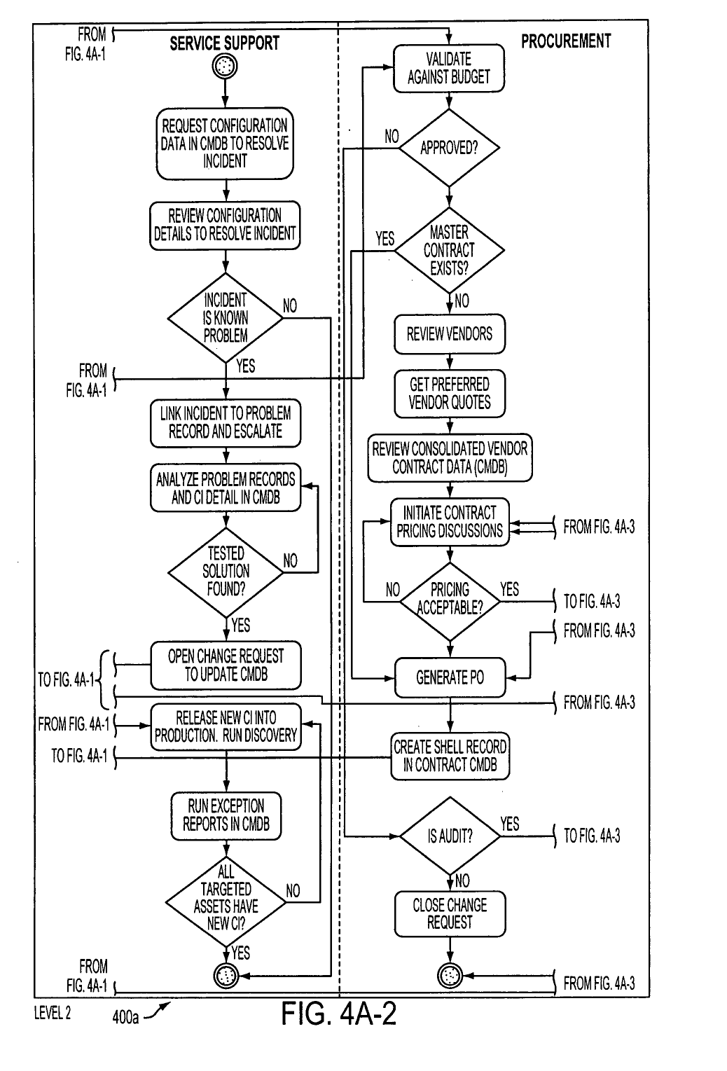

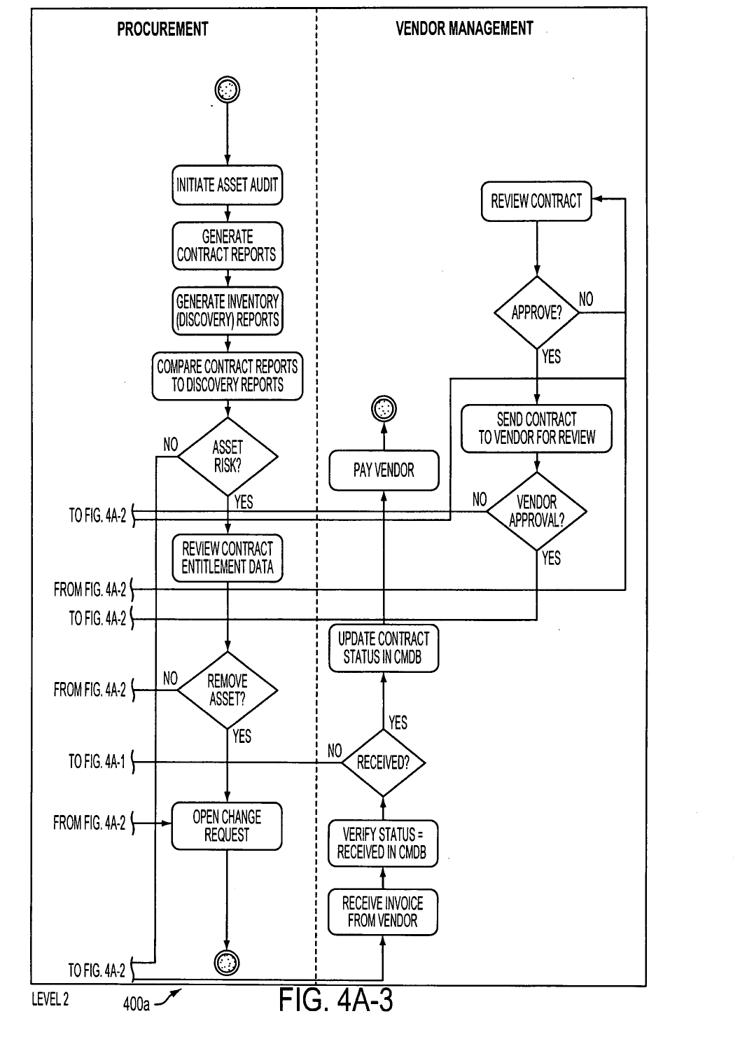

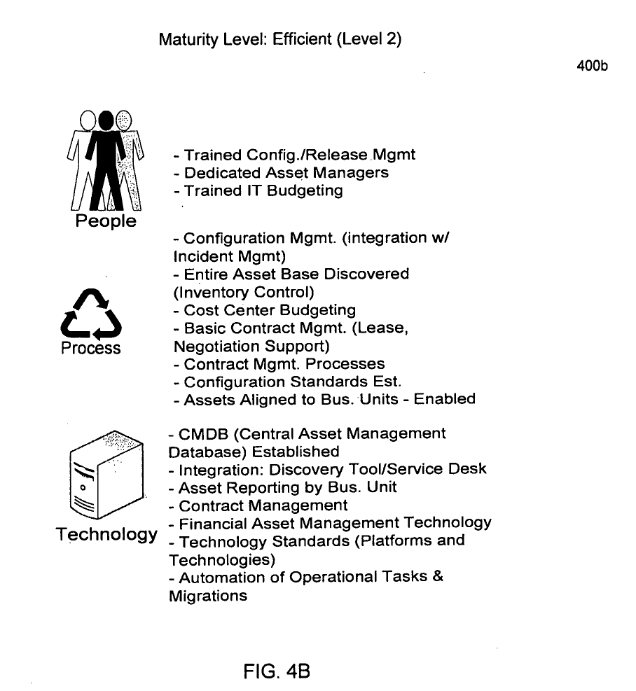

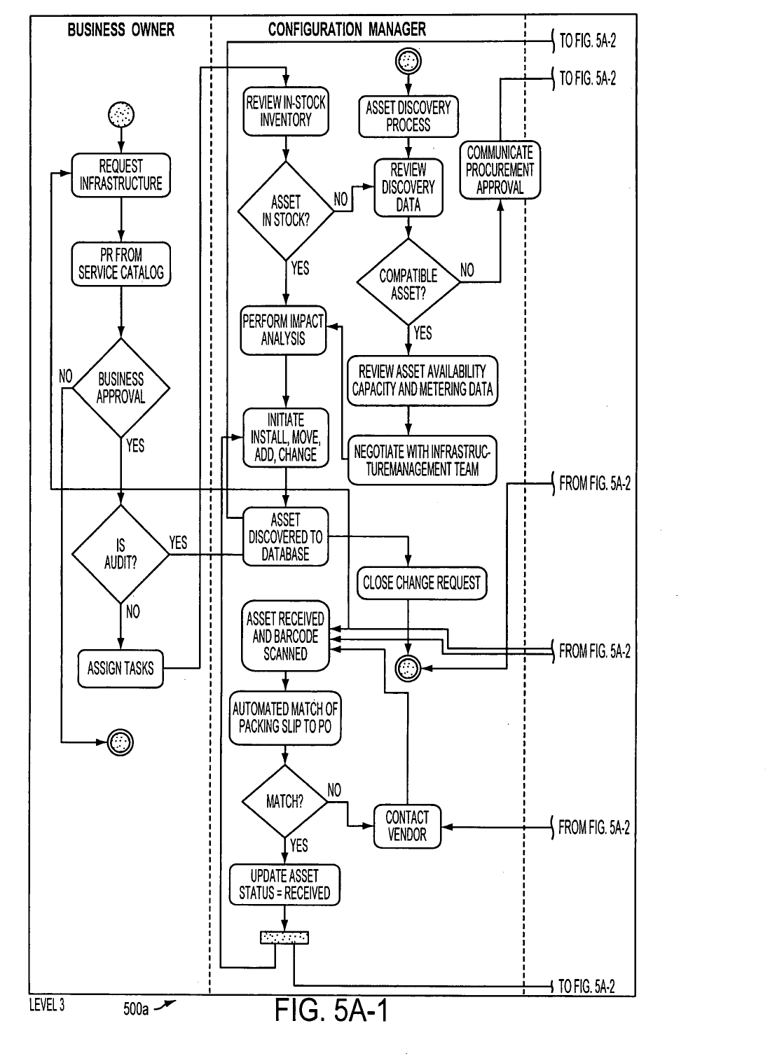

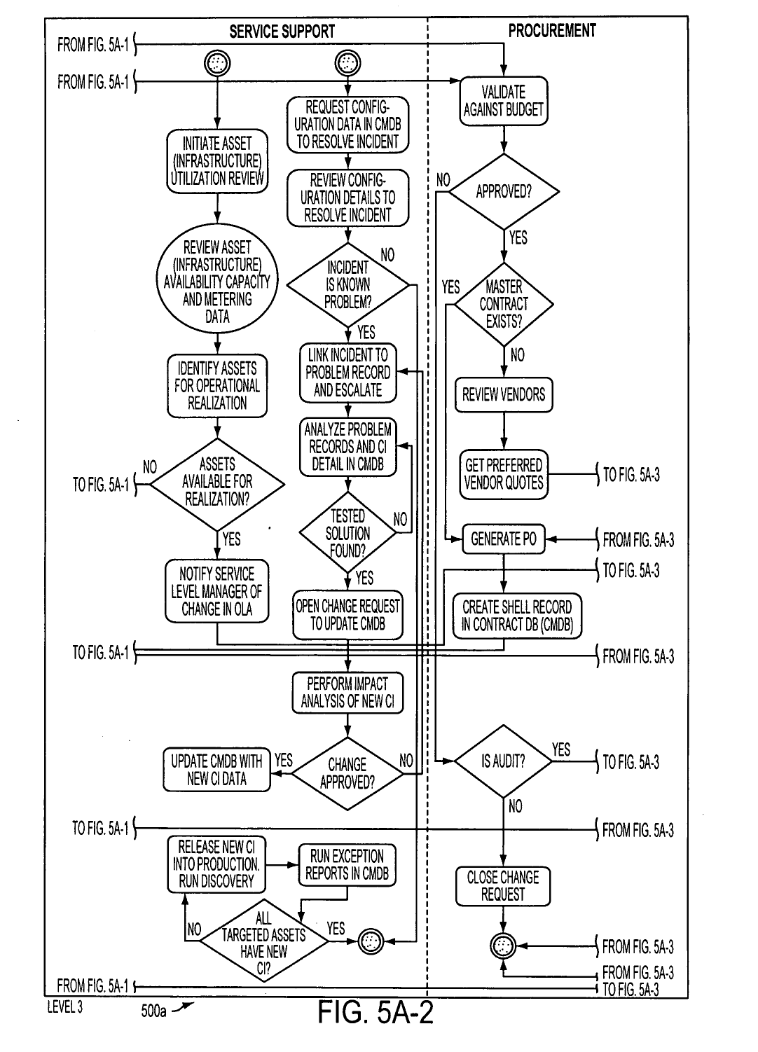

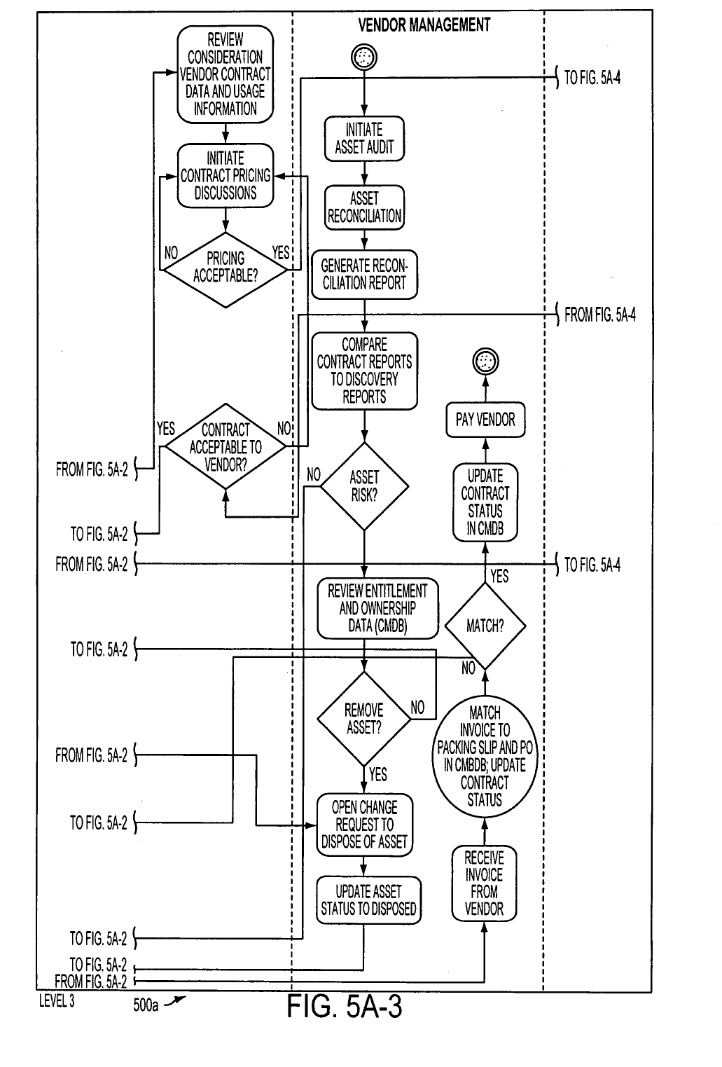

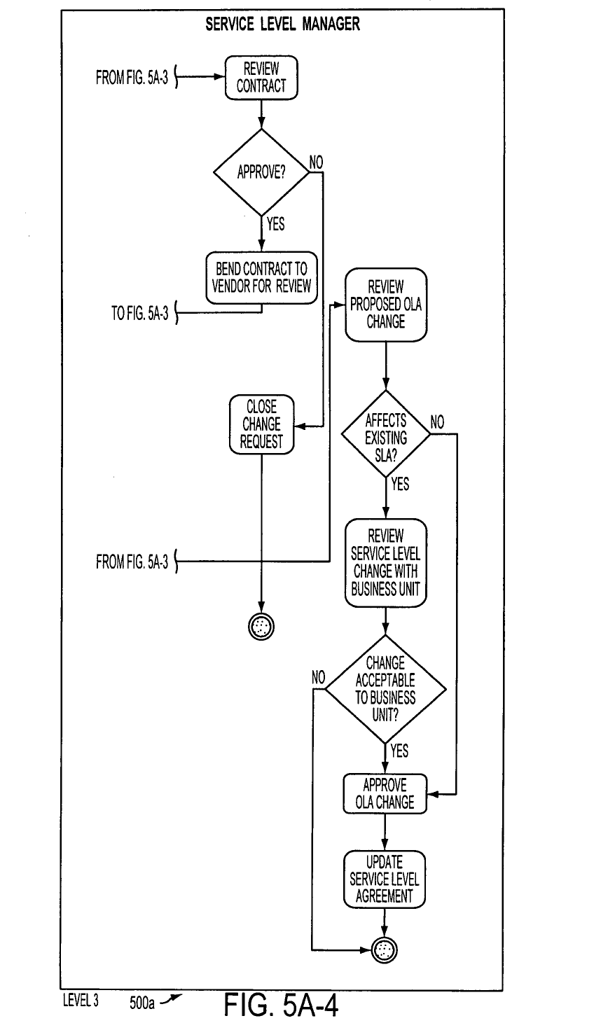

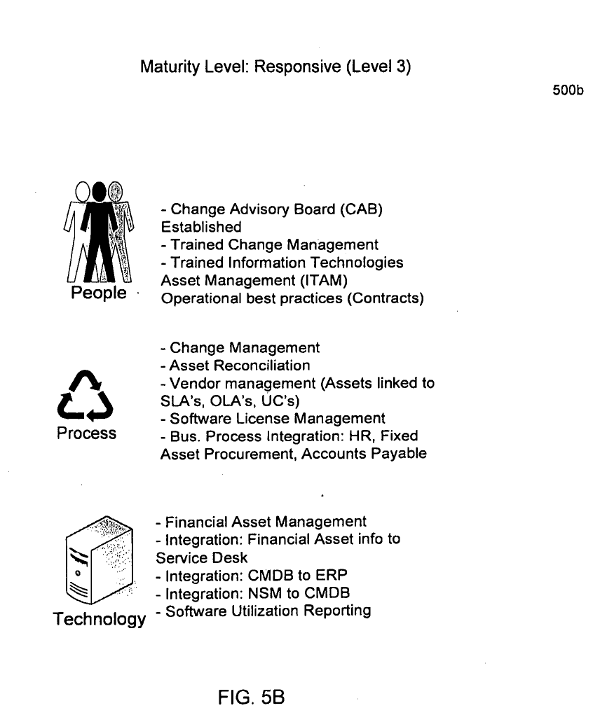

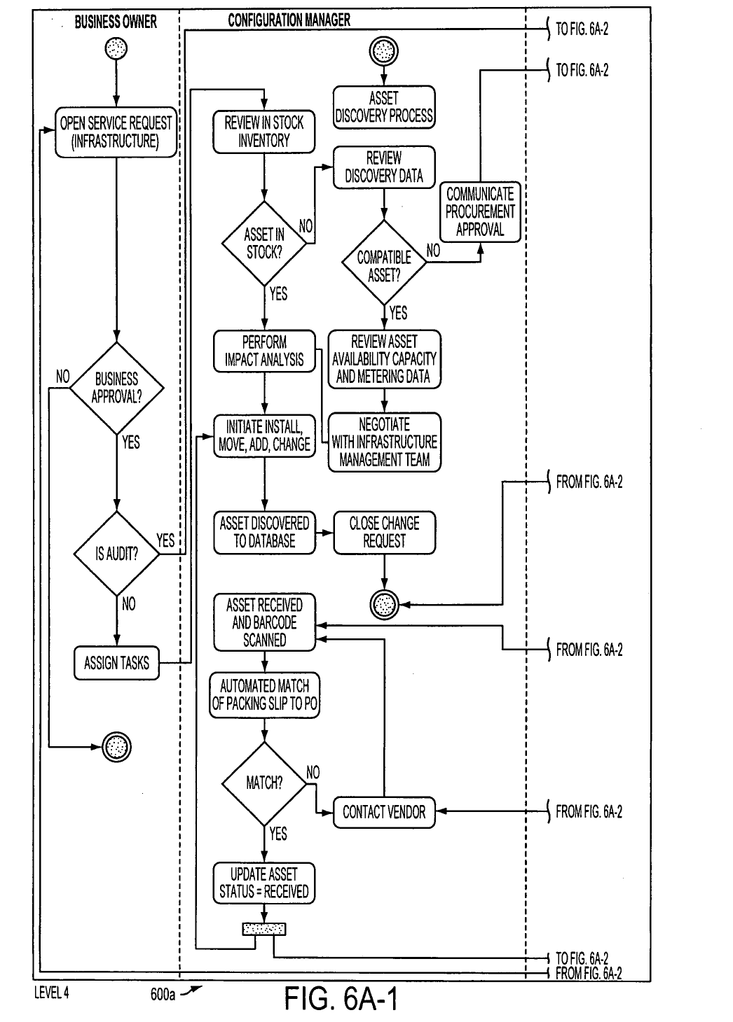

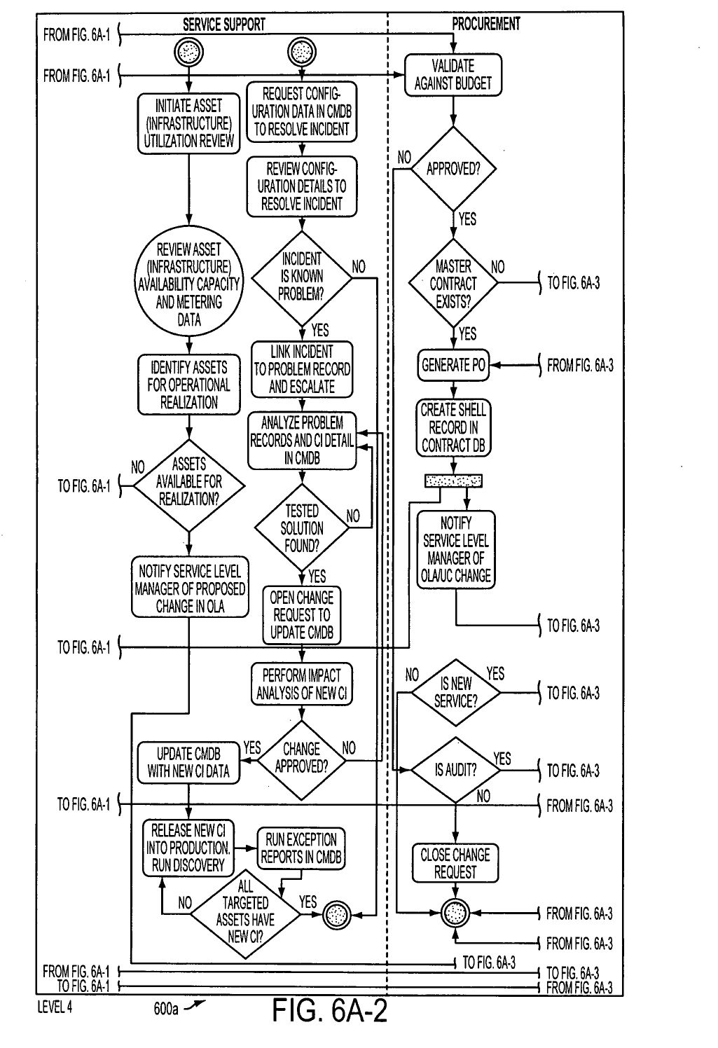

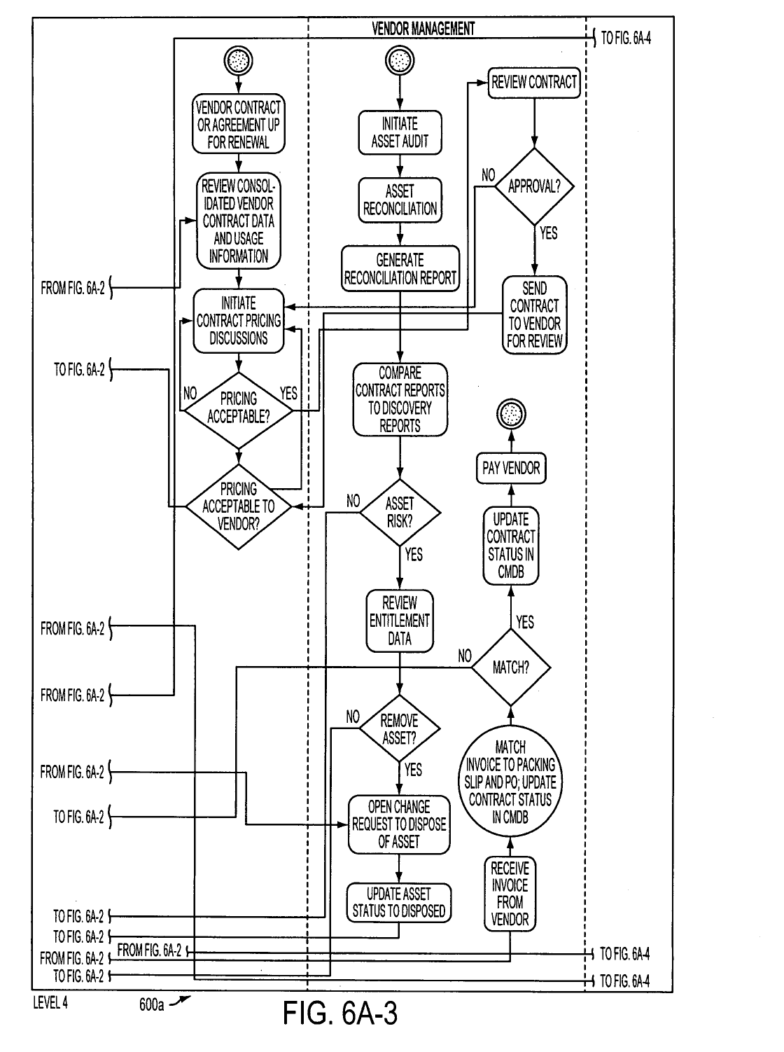

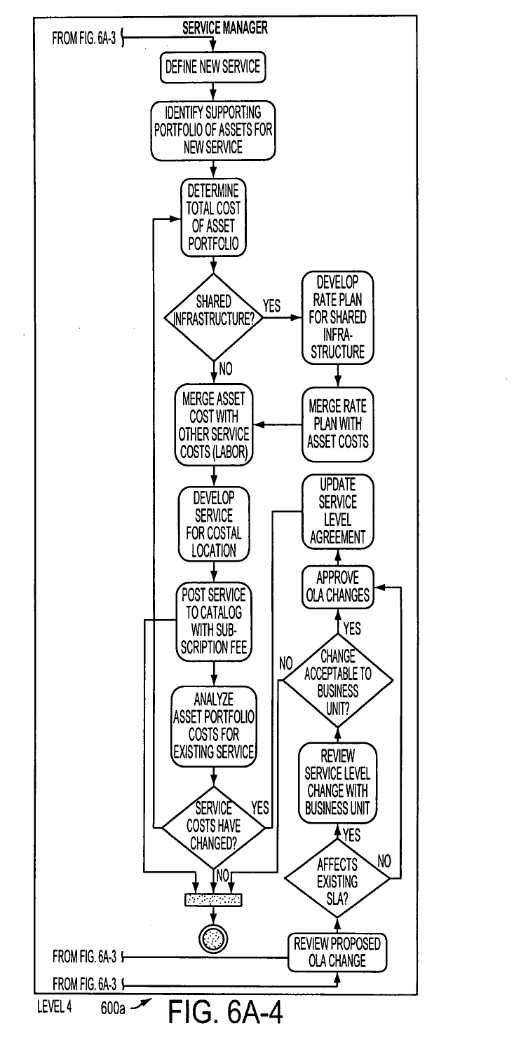

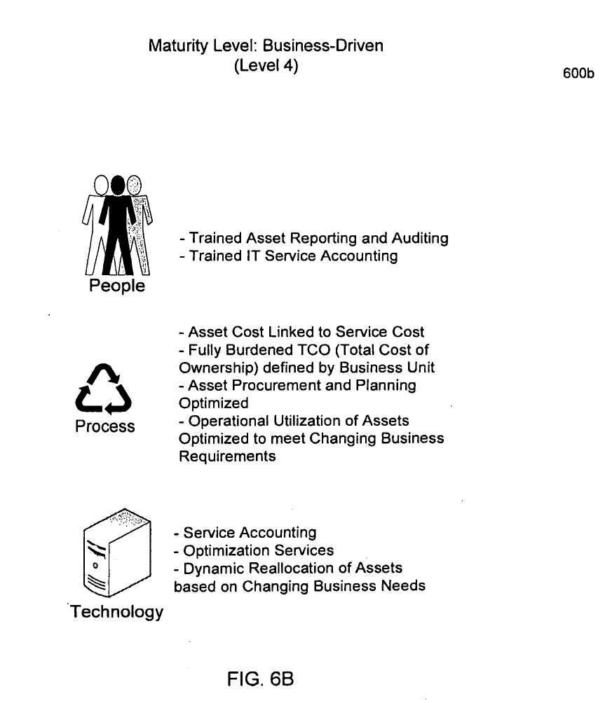

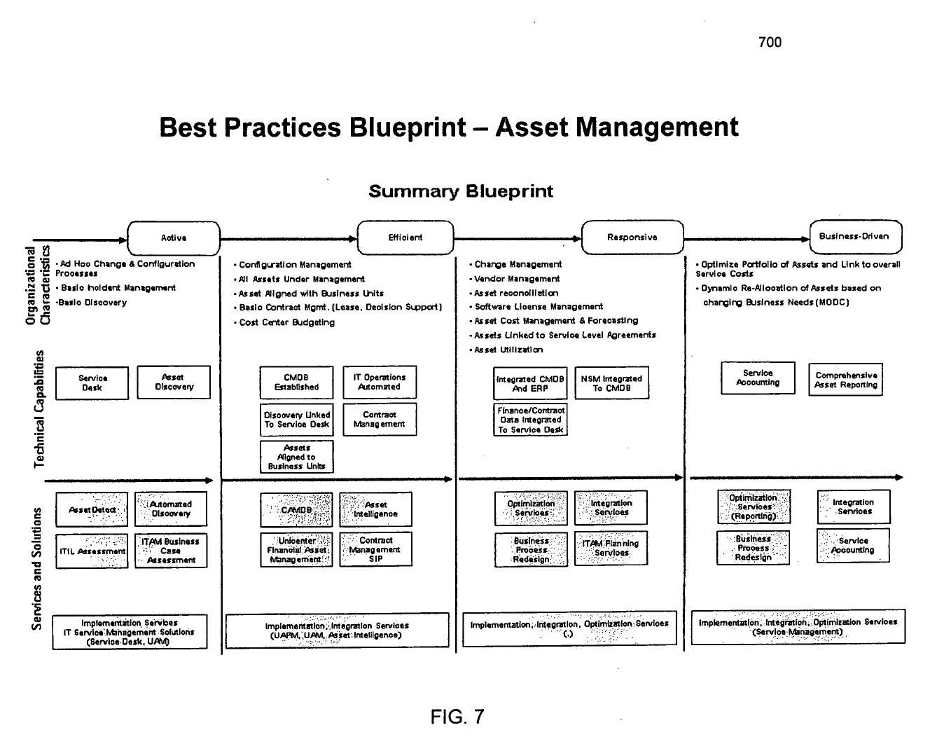

Similarly, FIGS. 4A and 4B illustrate an example process flow diagram 400a and an example characteristic list 400b, respectively, each containing examples of details regarding an Efficient asset management maturity level. FIGS. 5A and 5B illustrate an example process flow diagram 400a and an example characteristic list 400b respectively, each containing examples of details regarding a “Responsive” asset management maturity level. Finally, FIGS. 6A and 6B illustrate an example of a process flow diagram 400a and an example characteristic list 400b respectively, each containing elements for a Business-Driven change management maturity level. FIG. 7 illustrates an example of a summary blueprint for best practices in asset management across Active, Efficient, Responsive, and Business-Driven maturity levels. The summary blueprint includes details regarding organizational characteristics, technical capabilities, and services and solutions.

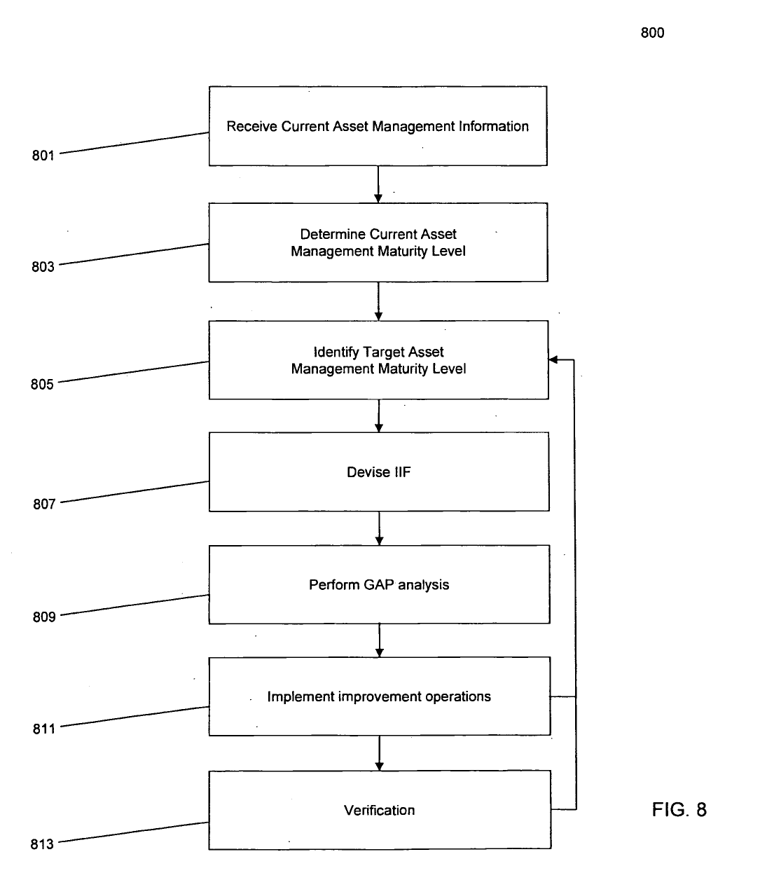

FIG. 8 illustrates a process 800 according to an embodiment of the invention, wherein an organization's asset management maturity level may be assessed and improved. In an operation 801, current asset management information may be gathered/received from the organization. In one embodiment, current asset management information may include data regarding the current people, processes, technology and/or other characteristics of the organization's asset management infrastructure. In an operation 803, a current asset management maturity level may be identified for the organization using the gathered current asset management information. For example, the current asset management information received from the organization (in operation 801) may be used to construct current asset management blueprints charts, lists or other documents, or assessments for the organization. These assessments may detail the people, processes, technology, and/or other characteristics of the organization's current asset management infrastructure. These assessments may then be compared to similar types of resources (e.g. blueprints, charts, lists, etc.) constructed for each of the predefined maturity levels in the hierarchy. The resources for the predefined maturity levels that most closely match the assessments representing the organization's current asset management structure may aid in the selection of the current asset management maturity level for the organization.

Once the current asset management maturity level of an organization is established using the operations described above, an operation 805 may be utilized to identify a target asset management maturity level. In some embodiments, the target asset management maturity level may include the maturity level immediately above the current maturity level in the hierarchy. For those organizations desiring to ultimately move up several maturity levels in the hierarchy, incremental movement from one maturity level to an immediately higher maturity level may be desirable, as incremental transitions may be more feasible or desirable. For example, an organization that is currently operating at an “Active” maturity level, may ultimately desire to move to a “Responsive” maturity level. However, an initial transition from Active to Efficient maturity levels may establish infrastructure and organizational precursors (e.g., people, processes, technology, etc.) that are beneficial in the further transition to the responsive maturity level. As such, the “target” maturity level, as the term relates to process 800 herein, refers to the maturity level to which the organization is immediately being shifted to, regardless of the ultimate level of maturity sought by the organization.

In some instances, however, the organization may be in a position such that transition directly to a maturity level that is several increments higher in the hierarchy is possible. As such, in some embodiments, the “target” maturity level may be several increments higher in the hierarchy than the current maturity level (e.g., the organization may be able to go from an Active directly to a Responsive maturity level).

In an operation 807 an integrated information technology flow (IIF) may be constructed for the identified target asset management maturity model. The IIF may include a list of the people, processes technology, processes flows, and/or other characteristics associated with both the current maturity model and the target maturity model. In an operation 809, a “gap” analysis may be performed, to discern one or more improvement operations that must be performed to transition the organization from the current asset management maturity level to the target asset management maturity level (i.e., to identify the “gap” between the two).

In some implementations, the one or more improvement operations may initially be outlined in a solution architecture overview (SAO). The solution architecture overview may represent a high level outline of the one or more improvement operations. In some embodiments, a provider of asset management improvement solutions (e.g., a service provider who directs, implements, oversees, or otherwise facilitates improvement of an organization's change management maturity level) may produce the solution architecture overview and present it to the organization as a preliminary plan for asset management improvement. The organization may review the solution architecture overview and make a decision as to whether to proceed with asset management improvement, whether to alter the one or more improvement operations reflected in the solution architecture overview, whether to refrain from asset management improvement, or other courses of action. Once the solution architecture overview has been approved by the organization, a solution architecture specification (SAS) may be produced. The solution architecture specification may include the detailed documentation regarding the one or more improvement operations performed to achieve the target maturity level, including: the steps that are to be taken to achieve the target maturity level; the software and other products that are going to be used; how those products are going to be installed; the processes to be implemented; the impact on the organization in terms of people, process and technology; or other information. In some embodiments, the solution architecture overview and/or the solution architecture specification may be constructed using industry and other “best practices” guidelines to design the one or more improvement operations. Some example the best practices guidelines for each maturity level can be seen in FIGS. 3A-7 and FIGS. 9-11.

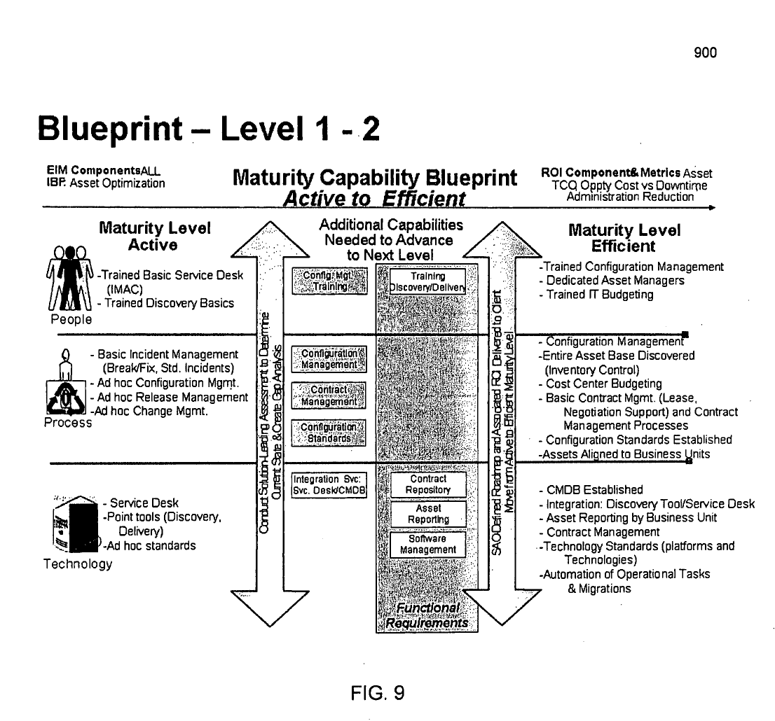

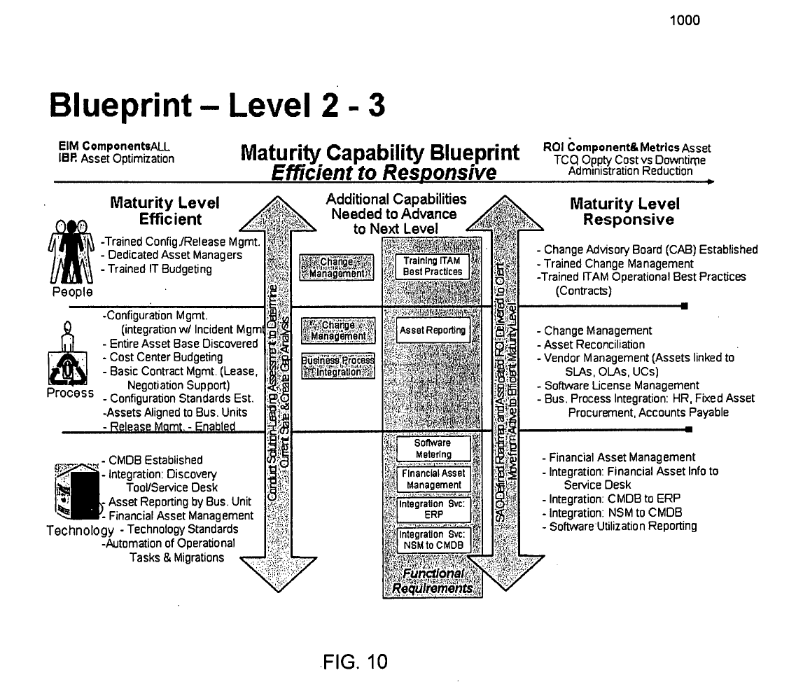

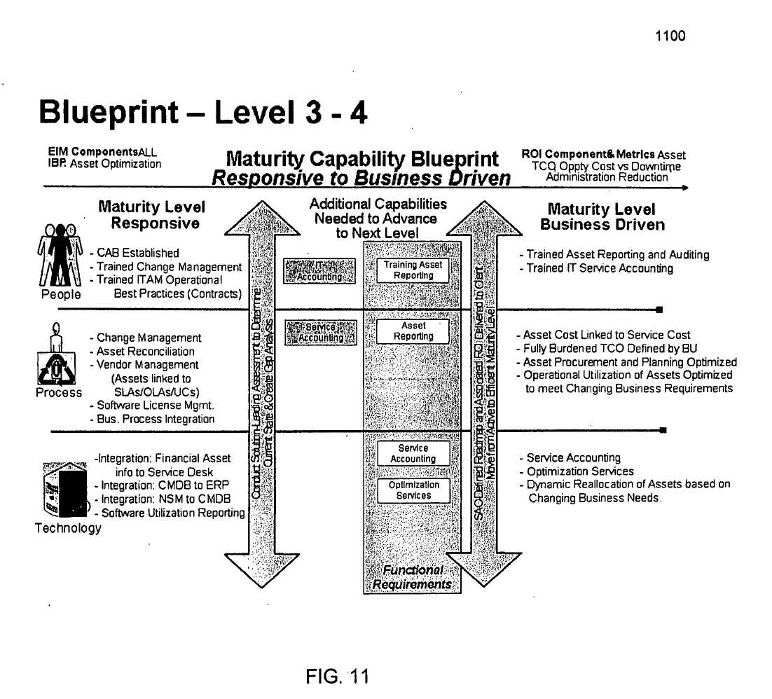

In some embodiments, the solution architecture overview and/or the solution architecture specification may be, at least in part, constructed using the IIF defined for transition from the current asset management maturity level to the target asset management maturity level, which aids in formulating improvements, additions, or other changes to the people, processes, technology, or other elements of the organization. For example, FIG. 9 illustrates an example of an IIF 900 that details the transition from an active asset management maturity level to an efficient asset management maturity level. IIF 900 illustrates the elements of asset management at the Active maturity level in terms of people, processes, and technology. IIF 900 also illustrates examples of some improvement operations and additional capabilities that may be included in a transition roadmap detailing a transition from an Active to an Efficient maturity level. IIF 900 also illustrates the elements of asset management at the resultant Efficient maturity level in terms of people, processes, and technology. FIG. 10 illustrates an IIF 1000 for shifting an organization from an Efficient to a Responsive change management maturity level. FIG. 11 illustrates a corresponding IIF 1100 for shifting an organization from a Responsive to a Business-Driven asset management maturity level.

In some embodiments, the solution architecture overview and/or the solution architecture specification may include additional elements such as, for example, detailed descriptions of the operations to be performed, a model of the organization operating within the target asset management maturity level, analysis of the impact of the implementation of the one or more improvement operations on the organization, one or more measurable critical success factors, or other elements.

As each organization's current asset management structure may be unique (e.g. advanced in some areas, deficient in others, deficient across the board), the one or more improvement operations needed to bring organizations to higher maturity levels may vary. For two different organizations, the specific asset management information gleaned from operation 801 may produce a different set of improvement operations when bringing the two separate organizations to the same maturity level.

Referring back to FIG. 8, in an operation 811, the one or more improvement operations may be performed (i.e., the solution designed in the SAO and SAS may be implemented), ultimately shifting the organization towards the higher asset management maturity level (the target level). These operations may be preformed by personnel or infrastructure internal to the organization, by external personnel or infrastructure (e.g., consultants or other service providers), or by a combination of both.

In an operation 813, the purported benefits of the organization's ascension to a higher maturity level may be verified post-implementation. In one embodiment, this verification may be accomplished using critical success factors and/or purported documented improvements, which may be measured after one or more of the one or more improvement operations have been performed. These critical success factors or improvements may be designed to determine the relative success or failure of the shift to the higher asset management maturity level. Other verification methods may be employed.

In some embodiments, one or more of the operations of process 800 may be repeated to shift the organization to an even higher asset management maturity level. Thus, in an embodiment of the invention involving predefined asset management maturity levels (e.g., Active, Efficient, Responsive, and Business-Driven), the invention may provide a stepwise solution for an organization to ultimately improve its asset management from a primitive or outdated structure to a best-in-class configuration. For example, this stepwise solution may take the organization incrementally from an Active maturity level, to an Efficient maturity level, to a Responsive maturity level, to a Business-Driven maturity level. For each shift in maturity levels, iterations of some or all of the operations in process 800 may be utilized to move up incremental maturity levels until the ultimately desired maturity level is reached.

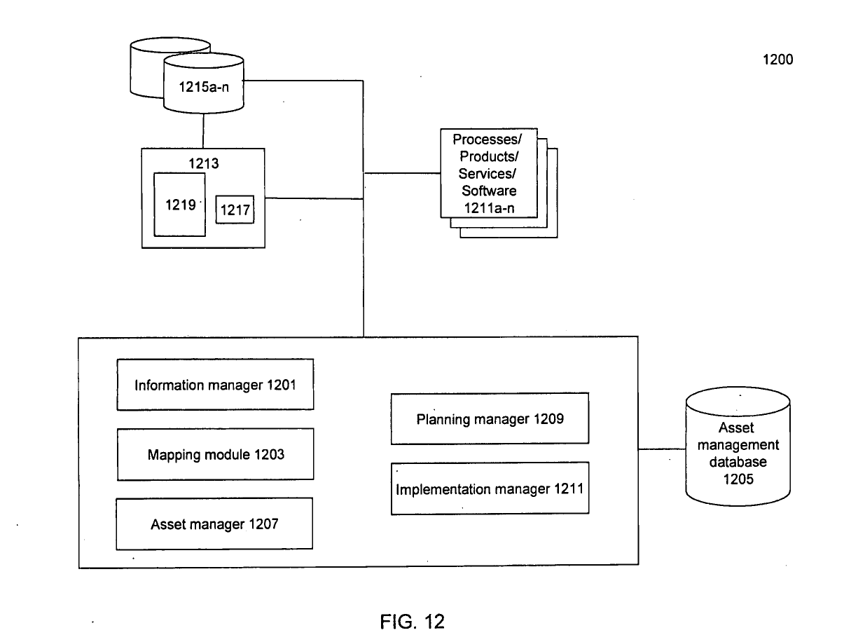

According to an embodiment of the invention illustrated in FIG. 12, the invention provides a system 1200 that enables performance of the processes, operations and/or features herein, including constructing an asset management database and asset usage models, utilizing an asset management database to meet organizational requirements, improving the asset management maturity level of an organization, and/or to perform other functions. System 1200 may include an information manager 1201, a mapping module 1203, an asset management database 1205, an assessment manager 1207, a planning manager 1209, an implementation manager 1211, and/or other elements.

In some embodiments, information manager 1201 may comprise one or more software modules, a person or group of people, a system or part thereof (including, but not limited to, a computer system), and/or other elements. Information manager 1201 may identify, receive, and/or store information, including: identifying assets managed by an organization, identifying business services/processes/organizational requirements, identifying metrics associated with assets, identifying information regarding an organizations asset management maturity level (or information used to identify a current maturity level), or to perform other processes, operations or features described herein. In one implementation, information manager 1201 may include or comprise an automated discovery agent.

In one embodiment, mapping module 1203 may comprise or include a software module that maps assets to business processes/requirements, assembles asset profiles (including metrics associated with assets), assembles asset usage models, stores information in asset management database 1205, and/or performs other features or functions of the invention.

In one embodiment, an assessment manager 1207 may comprise one or more software modules, a person or group of people, a system or part thereof (including, but not limited to, a computer system), and/or other elements. Assessment manager 1207 may determine if requirements can be met using certain assets (including comparing requirement attributes against assets), identify potential modifications to assets to meet requirements, assess the current asset management maturity level of an organization, and/or to perform other operations, processes or features described herein. In some embodiments, assessment manager 1207 may enable the determination/definition of a plurality of asset management maturity levels. In some embodiments, assessment manager 1207 may be utilized to define and arrange the maturity levels in a hierarchy. In some embodiments, assessment manager 1207 may construct blueprints, lists, charts or other representations or informational resources regarding one or more of the plurality of maturity levels.

In one embodiment, planning manager 1209 may include one or more software modules, a person or group of people, a system or part thereof (including, but not limited to, a computer system), and/or other elements. Planning manager 1205 may devise one or more improvement operations that, when implemented, will shift an organization to a higher asset management maturity level and/or to perform other processes, operations, or features described herein. In one embodiment, planning manager 1209 may enable construction and/or utilization of a solution architecture overview (SAO), a solution architecture specification (SAS), an integrated information technology flow (IIF), a prospective model of an organization under a higher maturity level, performance metrics, and/or other tools. In one embodiment, planning manager 1209 may identify one or more products/processes/services/software for use in the one or more improvement operations.

In one embodiment, implementation manager 1211 may include one or more software modules, a person or group of people, a system or part thereof (including, but not limited to, a computer system), and/or other elements. Implementation manager 1211 may generate procurement requests and or perform other operations necessary to evaluate vendors and acquire assets. Implementation manager 1211 may also perform the one or more improvement operations, implement the solution defined by the SAO and/or the SAS, measure and evaluate performance metrics, and/or to perform other processes, operations or features described herein. In some embodiments, implementation manager 1211 may utilize and/or implement one or more processes/products/services/software 1211a-n to shift an organization's asset management maturity level.

In some embodiments, one or more of the elements of system 1200 may include and/or utilize a computer system 1213, data storage devices 1215a-n, or other computer-implemented elements. In some embodiments, computer system 1213 may include a processor 1217 and a control application 1219. In some embodiments, control application 1219 may comprise a website or computer application and may include and or operate one or more software modules which cause processor 1217 to perform one or more processes, operations, or features described herein.

Those having skill in the art will appreciate that the invention described herein may work with various system configurations. Accordingly, more or less of the aforementioned system components may be used and/or combined in various embodiments. It should also be understood any software modules and/or software applications that may utilized to accomplish the functionalities described herein may be implemented in various combinations of hardware and/or firmware, in addition to, or instead of, software.

In one embodiment, the invention may include a computer readable medium containing instructions that, when executed by at least one processor, cause the at least one processor to enable and/or perform the features, functions, and or operations of the invention as described herein, including the any or all of the operations of the processes described in specification or the figures, and/or other operations.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A method for optimizing asset value within an organization, the method comprising:
identifying a plurality of assets managed by the organization;
for each of the plurality of assets:
identifying at least one business service supported by the asset,
measuring one or more metrics associated with the asset, and
developing a profile for the asset that includes the identified at least one business service and the one or more metrics;
constructing an asset usage model of at least one asset from the plurality of assets using at least one developed profile of the at least one asset, wherein the asset usage model includes one or more associations between the at least one asset and one or more business services supported by the at least one asset.

2. The method of claim 1, wherein measuring one or more metrics associated with the asset further comprises measuring the one or more metrics using an automated discovery module.

3. The method of claim 1, wherein the asset usage model identifies at least one operational efficiency achieved by the at least one asset, wherein an operational efficiency includes an asset supporting more than one business service.

4. The method of claim 1, further comprising identifying an additional business service for support by the at least one asset when the additional business service is not currently serviced by the at least one asset.

5. The method of claim 1, wherein the one or more metrics comprise one or more of consumer demand, requirements, capacity, corporate budgets, procurement, receiving, matching, reconciling, deploying, discovering, maintenance, entitlements, repurpose, and disposal.

6. The method of claim 1, wherein identifying a plurality of assets managed by the organization comprises identifying a subset of all assets managed by the organization.

7. The method of claim 1, wherein identifying a plurality of assets managed by the organization comprises identifying all of the assets managed by an organization.

8. A method for optimizing asset management within an organization utilizing an asset management database, the asset management database including an identity of a plurality of assets managed by the organization and associations between at least one of the plurality of assets and one or more existing organizational requirements serviced by the at least one of the plurality of assets, the method comprising:
identifying an additional organizational requirement of the organization;
determining whether the additional organizational requirement is serviceable using one or more assets from the plurality of assets managed by the organization;
updating the asset management database with at least an association between the additional organizational requirement and the one or more assets from the plurality of assets when the additional organizational requirement is serviceable using one or more assets from the plurality of assets;
initiating a procurement request for one or more additional assets to service the additional organizational requirement when the additional organizational requirement is not serviceable using any of the plurality of assets managed by the organization; and
updating the asset management database with at least an association between the additional organizational requirement and the one or more additional assets.

9. The method of claim 8, wherein identifying an additional organizational requirement further comprises validating, by the organization, the additional organizational requirement.

10. The method of claim 8, wherein determining whether the additional organizational requirement is serviceable using one or more assets from the plurality of assets managed by the organization includes determining whether one or more of the plurality of assets are immediately able to service the additional organizational requirement.

11. The method of claim 10, wherein determining whether the additional organizational requirement is serviceable using one or more assets from the plurality of assets managed by the organization further comprises determining whether one or more of the plurality of assets are adaptable to service the additional organizational requirement when one or more of the plurality of assets are not immediately able to service the additional organizational requirement.

12. The method of claim 8, wherein initiating a procurement request for one or more additional assets to service the additional organizational requirement further comprises identifying one or more vendors capable of filling the procurement request by supplying the one or more additional assets.

13. The method of claim 12, wherein initiating a procurement request for one or more additional assets to service the additional organizational requirement further comprises approving, by the organization, procurement of the one or more additional assets from the one or more identified vendors.

14. The method of claim 12, wherein initiating a procurement request for one or more additional assets to service the additional organizational requirement further comprises initiating a purchase order for procuring the one or more additional assets from the one or more identified vendors.

15. The method of claim 8, wherein the asset management database includes information relating to known problems relating to the one or more assets, and wherein determining whether the additional organizational requirement is serviceable using one or more assets from the plurality of assets managed by the organization further comprises considering the known problems.

16. The method of claim 8, wherein the asset management database includes service level management information relating to existing business services provided by the one or more assets, and wherein determining whether the additional organizational requirement is serviceable using one or more assets from the plurality of assets managed by the organization further comprises determining whether the existing business services will be disrupted if the one or more assets are used to service the additional organizational requirement.

17. The method of claim 8, wherein the asset management database includes asset risk information, and wherein initiating a procurement request includes determining whether the one or more additional assets include measurable asset risk.

18. A system for optimizing asset value within an organization using an asset management database, the system comprising:
an information manager that identifies a plurality of assets managed by the organization, wherein for each of the plurality of assets, the information manager:
identifies at least one business service supported by the asset,
measures one or more metrics associated with the asset, and
develops a profile for the asset that includes the identified at least one business service and the one or more metrics;
a mapping module that constructs an asset usage model of at least one asset from the plurality of assets using at least one developed profile of the at least one asset, wherein the asset usage model includes one or more associations between the at least one asset and one or more business services supported by the at least one asset,
wherein the asset usage model is stored in the asset management database.

19. A system for optimizing asset management within an organization utilizing an asset management database, the asset management database including an identity of a plurality of assets managed by the organization and associations between at least one of the plurality of assets and one or more existing organizational requirements serviced by the at least one of the plurality of assets, the system comprising:
an information manager that identifies an additional organizational requirement of the organization;
an assessment manager that determines whether the additional organizational requirement is serviceable using one or more assets from the plurality of assets managed by the organization;
a mapping module that updates the asset management database with at least an association between the additional organizational requirement and the one or more assets from the plurality of assets when the additional organizational requirement is serviceable using one or more assets from the plurality of assets;
an implementation manager that initiates a procurement request for one or more additional assets to service the additional organizational requirement when the additional organizational requirement is not serviceable using any of the plurality of assets managed by the organization; and
wherein the mapping module further updates the asset management database with at least an association between the additional organizational requirement and the one or more additional assets.
